(19) United States
(12) Patent Application Publication
(10) Pub. No.: US 2015/0119009 A1
(43) Pub. Date: Apr. 30, 2015

(54) METHOD AND APPARATUS FOR PROVIDING A CALLED IDENTIFIER TO A DEVICE ASSOCIATED WITH MULTIPLE IDENTIFIERS

(71) Applicant: VONAGE NETWORK LLC, Holmdel, NJ (US)

(72) Inventors: Sean Kucharski, Toms River, NJ (US); Andrew Bucko, Old Bridge, NJ (US); Stephen Hudek, Manalapan, NJ (US)

(73) Assignee: VONAGE NETWORK LLC, Holmdel, NJ (US)

(21) Appl. No.: 14/064,770

(22) Filed: Oct. 28, 2013

(51) Int. Cl. H04M 3/436; H04W 4/16

(52) U.S. Cl. CPC H04M 3/436; H04W 4/16
USPC 455/415

(57) ABSTRACT

Methods and apparatus for providing call identification to a device associated with one or more identifiers are provided herein. In some embodiments, a method for providing call identification to a terminal device associated with one or more communication identifiers may include extracting a called identifier from a message associated with a call from a caller device directed to the called identifier and terminating at the terminal device, wherein the called identifier is one of the one or more communication identifiers; and transmitting information associated with the called identifier to the terminal device.

### BACKGROUND OF THE INVENTION

1. Field of the Invention

Embodiments of the present invention generally relate to a method and apparatus for providing a called identifier to a device associated with multiple identifiers.

2. Description of the Related Art

Often, telecommunication devices are associated with multiple call identifiers. For example, a user of a mobile phone is given a call identifier (telephone number) from a mobile provider, and may also register an account with one or more VoIP providers, each providing an identifier, for use from the same mobile device. Additionally, some users may have multiple call identifiers for personal use, business use and the like, each terminating at the same device. When the user receives a call on the mobile device, the user has no way of identifying how the call terminated at their mobile device, i.e., which identifier was used to contact the user. For example, if someone calls a particular business identifier of the user, the call will terminate to the same device as the user's other business and/or personal call identifiers. The user will have no way of knowing which call identifier was dialed by the caller, i.e., how the call got to the recipient.

In other instances, the device itself may have a single identifier associated with it; however, a user may assign rules such as call forwarding, “simulring”, call hunt, or the like. Again, the call recipient will have no way of identifying how the call was placed and terminated at their mobile device without inquiring with the caller.

What is needed is a method and apparatus for identifying the identifier used by a calling party to reach the recipient, in accordance with exemplary embodiments of the present invention.

### SUMMARY OF THE INVENTION

Methods and apparatus for providing call identification to a device associated with one or more identifiers are provided herein. In some embodiments, a method for providing call identification to a terminal device associated with one or more communication identifiers may include extracting a called identifier from a message associated with a call from a caller device directed to the called identifier and terminating at the terminal device, wherein the called identifier is one of the one or more communication identifiers; and transmitting information associated with the called identifier to the terminal device.

In some embodiments, a method for providing call identification to a user of a terminal device associated with one or more communication identifiers may include receiving a called identifier in a message associated with a call from a caller device directed to the called identifier and terminating at the terminal device, wherein the called identifier is one of the one or more communication identifiers; and alerting a user associated with the terminal device about information associated with the called identifier.

In some embodiments, an apparatus for providing call identification to a user of a terminal device associated with one or more communication identifiers may include at least one processor, at least one input device, and at least one storage device storing processor-executable instructions which, when executed by the at least one processor, performs a method. In some embodiments, the method may include extracting a called identifier from a message associated with a call from a caller device directed to the called identifier and terminating at the terminal device, wherein the called identifier is one of the one or more communication identifiers; and transmitting information associated with the called identifier to the terminal device.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram of a communications environment including various elements which are associated with an Internet protocol (IP) telephony system operating in accordance with the invention;

FIG. 2 depicts an identification module 200 for providing caller identification to a device associated with multiple identifiers in accordance with exemplary embodiments of the present invention;

FIG. 3 illustrates a graphical alert in accordance with exemplary embodiments of the present invention;

FIG. 4 is a block diagram depicting a computer system for implementing the apparatus of FIG. 1 in accordance with exemplary embodiments of the present invention;

FIG. 5 is a flow diagram illustrating a method 500 for providing call identification to a device associated with one or more identifiers in accordance with exemplary embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method for providing caller identification to a device associated with multiple identifiers. For example, if a person has several business lines and several personal lines, each of which has call forwarding enabled, where the call forwarding is directed to a single terminal device, the person has no way of knowing which line a caller had originally selected or dialed. In other instances, a user may have enabled call hunt, which calls each device specified by the user in a list until the list is exhausted, or SIMULRING, which simultaneously rings all the devices in the list until the user receives the call on one of the devices. In some embodiments of the present invention, the identifier selected during call initiation (i.e., the called identifier) is extracted from any call forwarding, call hunt, or SIMULRING mechanism and forwarded to the terminating device. The person is alerted to an incoming call in addition to the call identifier originally selected by the calling party. According to some embodiments of the present invention, the person (i.e., the called party), can return the call to the caller and set their identifier to be the called identifier originally specified by the calling party.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

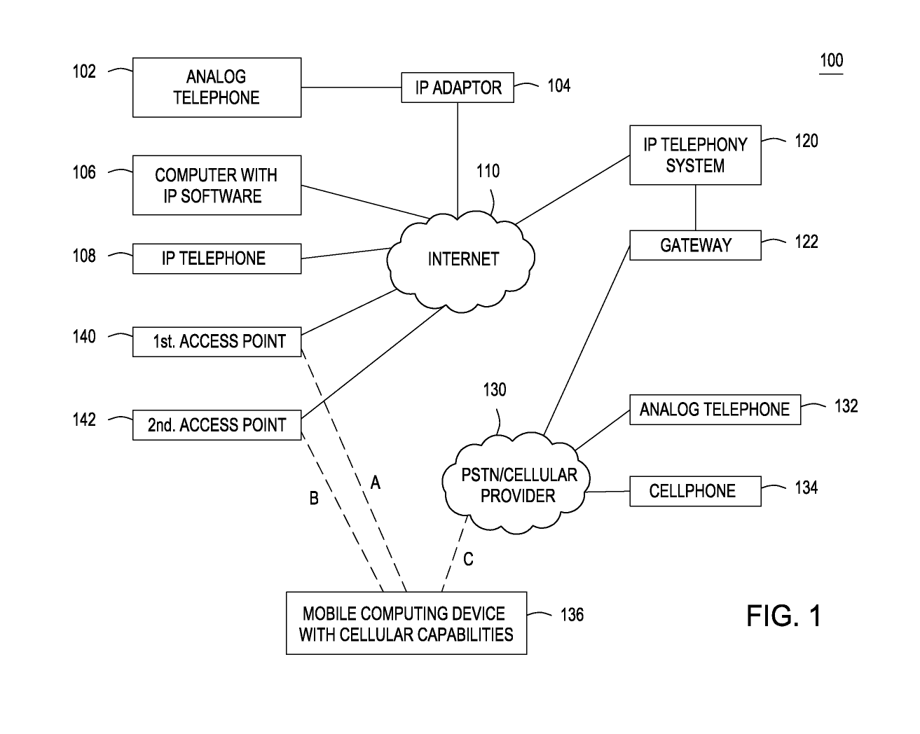

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may be provisioned by the IP telephony system 120.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a telephone adaptor 104 that is connected to one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE iPhone™, that includes both cellular telephone capabilities and a wireless data transceiver that can establish a wireless data connection to a data network. Such a mobile computing device could run appropriate application software to conduct VOIP telephone calls via a wireless data connection. Thus, a mobile computing device, such as an APPLE iPhone™, a RIM BLACKBERRY or a comparable device running GOOGLE's ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE iPod Touch™ and the iPad™. Such a device may act as a mobile telephony device once it is configured with appropriate application software.

FIG. 1 illustrates that a mobile computing device with cellular capabilities 136 is capable of establishing a first wireless data connection A with a first wireless access point 140, such as a WIFI or WIMAX router. The first wireless access point 140 is coupled to the Internet 110. Thus, the mobile computing device 136 can establish a VOIP telephone call with the IP telephony system 120 via a path through the Internet 110 and the first wireless access point 140.

FIG. 1 also illustrates that the mobile computing device 136 can establish a second wireless data connection B with a second wireless access point 142 that is also coupled to the Internet 110. Further, the mobile computing device 136 can establish a third wireless data connection C via a data channel provided by a cellular service provider 130 using its cellular telephone capabilities. The mobile computing device 136 could also establish a VOIP telephone call with the IP telephony system 120 via the second wireless connection B or the third wireless connection C.

Although not illustrated in FIG. 1, the mobile computing device 136 may be capable of establishing a wireless data connection to a data network, such as the Internet 110, via alternate means. For example, the mobile computing device 136 might link to some other type of wireless interface using an alternate communication protocol, such as the WIMAX standard.

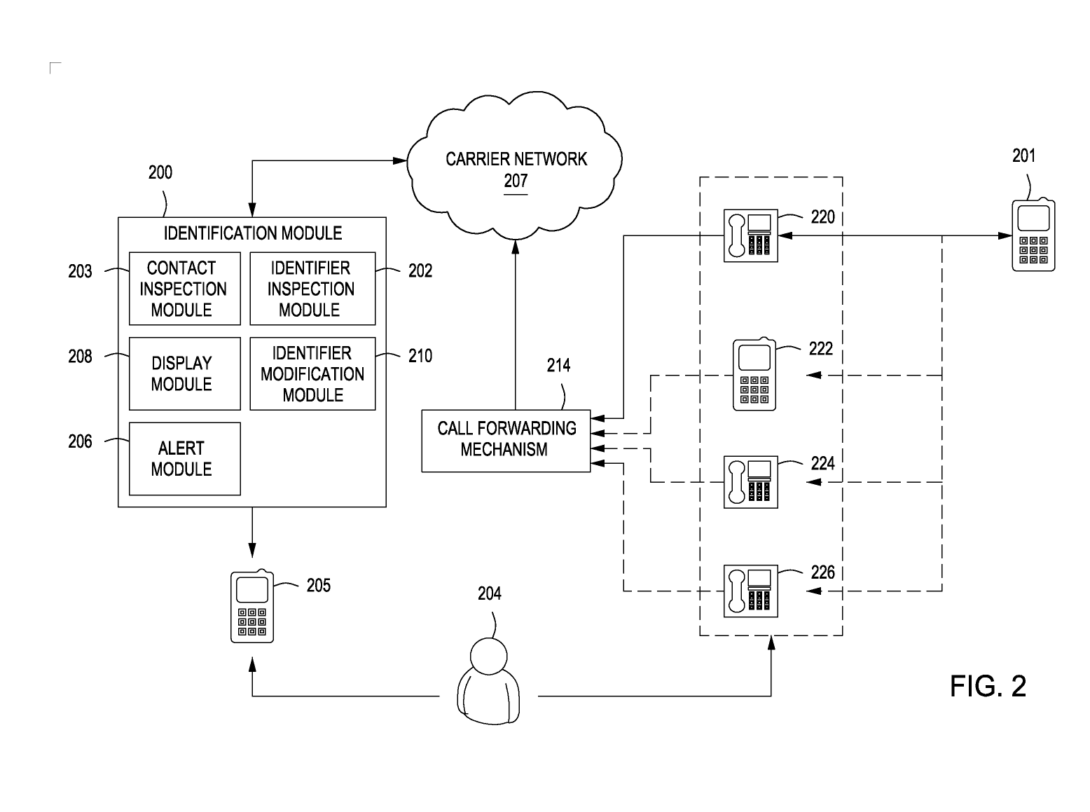

FIG. 2 depicts an identification module 200 for providing caller identification to a device associated with multiple identifiers in accordance with exemplary embodiments of the present invention. The identification module 200 comprises an identifier inspection module 202, a contact inspection module 203, an alert module 206, a display module 208 and an identifier modification module 210. According to the scenario presented in FIG. 2, a calling party attempts to contact a called party 204 via the device 201. The device 220 may be a first business line for the person's contracting business, for example. The called party 204 may also have several other lines, such as personal line 222, a second business line 224, and a third business line 226, each with corresponding identifiers. For the purposes of discussion, the devices 220 to 226 will be interchangeably be referred to as identifiers 220-226. In some embodiments, the identifiers may be telephone numbers, or the like. The devices 220-226 may be mobile telephones, tablets, computers, laptops, VoIP terminal units, or the like.

In one scenario, the calling party dials, via the device 201, an identifier (the “called identifier”) associated with the line that terminates at device 220. The called party 204 has enabled call forwarding via a call forwarding mechanism 214 on the device 220, so that if called party 204 is not physically able to answer a call received at device 220, the call is forwarded to the terminal device 205. The identification module 200 receives the forwarded call via a carrier network 207 and modifies an alert on the device 205 indicating to the called party 204 that a call is incoming. The identification module 200 presents the terminal device 205 with the caller ID of the calling party from device 201 in addition to the called identifier associated with the device 220. By providing the terminal device 205 with the caller ID of the calling party from device 201 in addition to the called identifier associated with the device 220, the identification module 200 causes a display of device 205 to display the identifier of the calling party from device 201 (or information associated with or derived from the identifier of the calling party), in addition to the called identifier associated with the device 220 (or information associated with or derived from the identifier of the called party 204). In another example, if the calling party originally dialed the identifier associated with device 222, 224 or 226, the corresponding identifier of that device is shown or indicated as the called identifier presented to terminal device 205.

According to one embodiment, the identification module 200 resides as an application on the user device 205. In other embodiments, the identification module 200 may be stored and executed on a server within the carrier network 207, or within a network local to the device 205. According to some embodiments, a user (such as called party 204) may configure the identification module 200 to alert called party 204 according to their preference. For example, the identification module 200 comprises the alert module 206, which called party 204 can configure to modify how the called identifier is provided to the terminal device 205, or how they are alerted to which identifier was selected to reach them.

The alert module 206 may be configured to generate a unique audio tone corresponding to the called identifier. The audio tone may be a ring tone, or another tone that sounds after the ring-tone has completed, with each audio tone corresponding to a called identifier. For example, each device 220-226 may be associated with a distinct tone identifying the device/identifier. In other instances, the alert module 206 may be coupled to the display of device 205 via the display module 208, providing a visual indication of the called identifier on terminal device 205. Optionally, the alert module 206 may also provide an indication of what rule (e.g., call forwarding, call hunt, SIMULRING) was invoked to reach terminal device 205.

According to some embodiments, if the user 204 does not answer the incoming call, the incoming call information comprising the called identifier, the calling identifier and other telephony information is recorded in a database. An application that runs on device 205 may then access that information and present received, placed and/or missed calls to the user 204. For example, if the caller (using device 201) called the identifier associated with device 224 (e.g., identifier A), and the call forwarding mechanism 214 forwarded the call to the device 205 (e.g., device associated with identifier B), the identification module 200 will record all information associated with the call in a database. If the user 204 does not answer the call, the call will be placed in a missed call list in the database. According to exemplary embodiments, the database can be local or remote from the device 205 and accessed via network 207.

The user 204 may then select the missed call in order to return the call, i.e., contact the user of device 201. However, since the user of device 201 called user 204 by dialing identifier A, the caller may not realize why a user with identifier B appears on the original caller's device 201. The identifier modification module 210 of the identification module 200 enables the user 204 to “emulate” a call using the identifier A. It will appear to the user of device 201 that a call from device 220 is incoming. When the user 204 selects the identifier of device 201 from an embedded application, the identifier modification module 210 changes identifier B to identifier A. When the call is placed via the network 207 to the user of the device 201, the user of the device 201 will see that a caller with a call identifier as identifier A is returning their call, allowing the user 204 to maintain a plurality of business identifiers and personal identifiers while physically absent from the devices 220, 222, 224 and 226 associated with those identifiers.

Those of ordinary skill in the art will recognize there are various ways to modify the identifiers in the embodiments described herein. For example, according to some embodiments, the identifier is modified via the use of Session Initiation Protocol (SIP) headers or the like, as the call is placed. Specifically, in some embodiments, proprietary SIP headers may be used to store the identifiers (e.g., the calling party and called party identifiers), while in other embodiments existing SIP header fields may be used to store the identifiers. The SIP headers may include the called identifier as the outgoing identifier when a call is returned. The identifier modification module 210 may extract the identifiers from the SIP headers. In some embodiments, other types of call setup messages (e.g., SS7, and the like) may be used to modify the identifiers in the embodiments described herein. The use of proprietary headers implies that the terminal device 205 is provisioned to or otherwise enabled to understand the information contained in such headers. This could be the case, for example, if the terminal device 205 is on the same network as the identification module 200.

In some embodiments, if the called identifier is from a different network than the terminal device 205, the called identifier may be forwarded to the device 205 via an out-of-band method such as a message (for example, an SMS message), or over a voice channel as auditory information

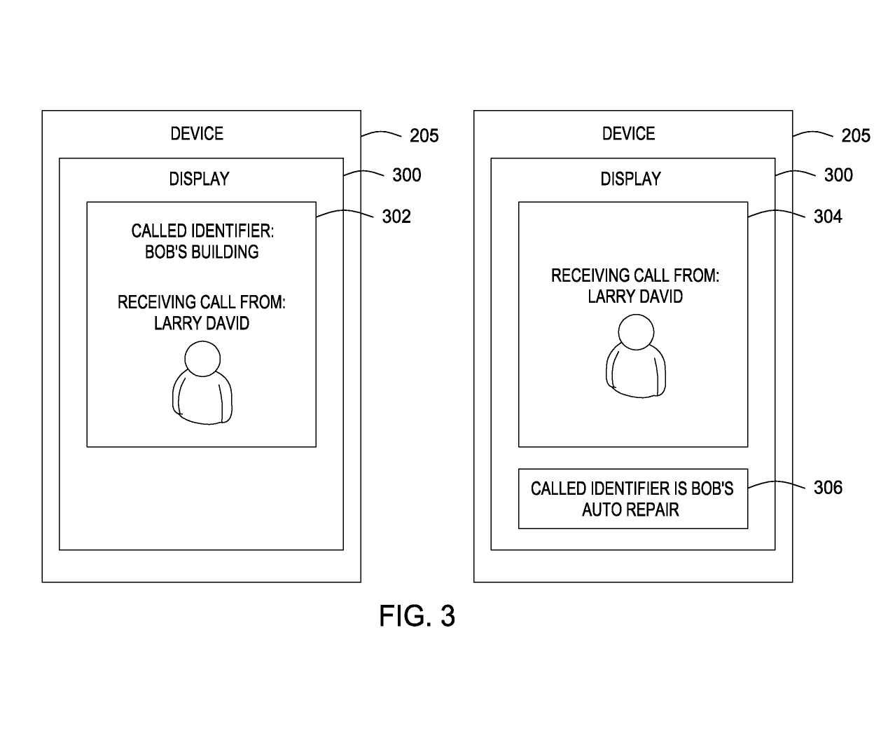

FIG. 3 illustrates a graphical alert in accordance with exemplary embodiments of the present invention. A graphical display 302 on the display 300 of device 205 may indicate the called identifier, or information associated with or derived from the called identifier, for example “BOB'S BUILDINGS”. According to one embodiment, the contact inspection module 203 shown in FIG. 2 inspects all contacts of the user 204 stored in device 205 (or stored externally) and matches the identifier associated with the calling device 201. Once a match is determined for the calling device 201, i.e., “Larry David”, the contact is temporarily modified by the contact inspection module 203 so that the called identifier, or information associated with or derived from the called identifier, is concatenated to the contact information as shown in block 302, allowing the user 204 to determine not only who the caller is, but which identifier they called to reach device 205. According to another embodiment, the identification module 200 has access to lower level graphical capabilities of device 205 via the alert module 206 and generates a graphical alert 306 displaying the called identifier to the user 204 along with the contact information 304. In yet another embodiment, the alert module 206 may alert the user 204 about the called identifier via a short message service (SMS) message or the like, where the message may be displayed in the graphical alert 306. Those of ordinary skill in the art would recognize that a multitude of graphical configurations are possible and the presentation of the called identifier shown in FIG. 3 is merely exemplary and not limiting in any way. In other embodiments, an audio-generating system may play a brief audio prompt to announce the called identifier to the callee, either in addition to or instead of a graphical display of the called identifier.

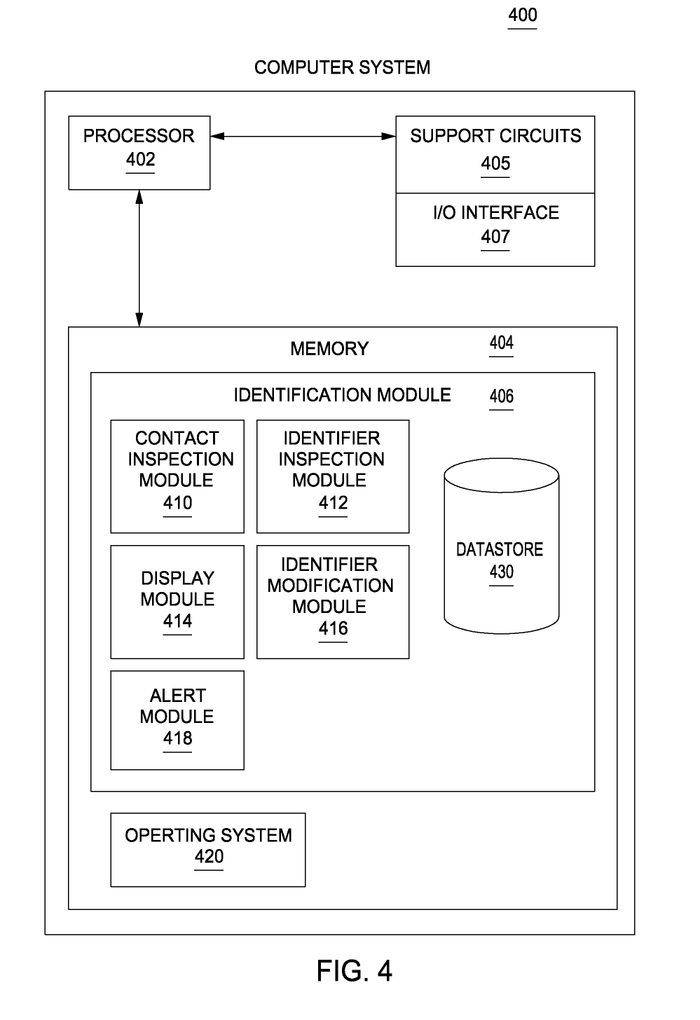

FIG. 4 is a block diagram depicting a computer system 400 for implementing exemplary embodiments of the present invention. The computer system 400 includes a processor 402, various support circuits 405, and memory 404. The processors 402 may include one or more microprocessors known in the art. The support circuits 405 for the processor 402 include conventional cache, power supplies, clock circuits, data registers, I/O interface 407, and the like. The I/O interface 407 may be directly coupled to the memory 404 or coupled through the support circuits 405. The I/O interface 407 may also be configured for communication with input devices and/or output devices such as network devices, various storage devices, mouse, keyboard, display, video and audio sensors and the like.

The memory 404, or computer readable medium, stores non-transient processor-executable instructions and/or data that may be executed by and/or used by the processor 402. These processor-executable instructions may comprise firmware, software, and the like, or some combination thereof. Modules having processor-executable instructions that are stored in the memory 404 comprise an identification module 406 and a datastore 430. The identification module 406 further comprises a contact inspection module 410, an identifier inspection module 412, a display module 414, an identifier modification module 416 and an alert module 418.

The computer system 400 may be programmed with one or more operating systems 420, which may include OS/2, Linux, SOLARIS, UNIX, HPUX, AIX, WINDOWS, 10S, and ANDROID among other known platforms.

The memory 404 may include one or more of the following: random access memory, read only memory, magneto-resistive read/write memory, optical read/write memory, cache memory, magnetic read/write memory, and the like, as well as signal-bearing media as described below.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

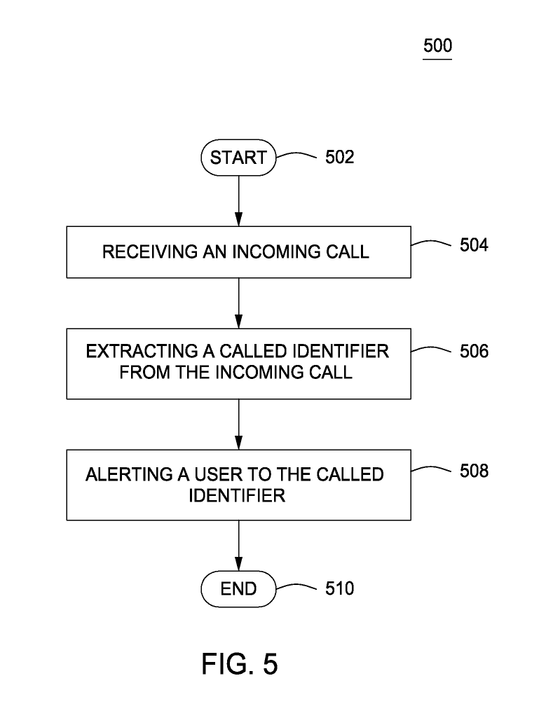

FIG. 5 is a flow diagram illustrating a method 500 for providing call identification to a device associated with one or more identifiers in accordance with exemplary embodiments of the present invention. Method 500 illustrates an exemplary flow of the identification module 406 stored in memory 404 and executed via the processor 402 of computer system 400. The computer system 400 is an exemplary implementation of the identification apparatus 200 shown in FIG. 2.

The method begins at step 502 and proceeds to step 504. At step 504, an incoming call is received via a device. The call may originate from any type of network and may be directed to an identifier such as a telephone number or the like. In some instances, the call is being forwarded from a landline, mobile phone, or the like, via a call forwarding mechanism such as mechanism 214 shown in FIG. 2. At step 506, the identifier inspection module 412 inspects the incoming call information and extracts the calling identifier in addition to the called identifier. Those of ordinary skill in the art will recognize that these are just examples of the type of information that may be extracted from the incoming call and other information may also be inspected and extracted.

At step 508, the alert module 418 causes the user of the device to whom the call is directed, or the call is forwarded, to be alerted to the called identifier as well as the caller information. For example, the user of the device may be shown a graphical icon indicating that the call was initially directed to their business line via the display module 414, and therefore they may answer the call appropriately. If the call was directed towards a personal line, the user may answer in a more casual manner and not disclose any business information. The called individual has control over how to answer the incoming call based on the additional information provided to them via the identification module 406. In some embodiments, the contact inspection module 410 may have previously received the contacts of the user of the device, and may concatenate, or cause the called identifier to be concatenated to the calling contact display information. The method terminates at step 510.

While the foregoing is directed to embodiments of the present invention, other and further embodiments of the invention may be devised without departing from the basic scope thereof, and the scope thereof is determined by the claims that follow.

1. A method for providing call identification to a terminal device, comprising:
extracting a first called identifier from a message associated with a call originating from a caller device directed to the first called identifier, wherein the call is forwarded to the terminal device associated with a second called identifier that is different from the first called identifier;
transmitting information associated with the first called identifier to the terminal device;
modifying a terminal identifier of the terminal device received in a second message associated with a return call originating from the terminal device to the caller device using the first called identifier; and
transmitting the modified terminal identifier to the caller device.

2. The method of claim 1, wherein a caller identifier associated with the caller device is extracted from the message, and wherein the transmitted information further includes information associated with the caller identifier associated with the caller device.

3. The method of claim 2, wherein transmitting is performed via a short message service (SMS) or through an audio channel.

4. The method of claim 1, wherein the message is a Session Initiation Protocol (SIP) message.

5. A method for providing call identification to a user of a terminal device, comprising:
receiving a first called identifier in a message associated with a call originating from a caller device directed to the first called identifier and terminating at the terminal device, wherein the terminal device is associated with a second called identifier, the first called identifier different from the second called identifier;
alerting a user associated with the terminal device about information associated with the first called identifier;
modifying a terminal identifier of the terminal device received in a second message associated with a return call originating from the terminal device to the caller device using the first called identifier; and
transmitting the modified terminal identifier to the caller device.

6. The method of claim 5, wherein the first called identifier is extracted from the message.

7. The method of claim 5, wherein alerting the user includes displaying a graphical alert on the terminal device including the information associated with the first called identifier.

8. The method of claim 7, wherein at least one of the first called identifier or a name of an entity associated with the first called identifier is displayed in the graphical alert.

9. The method of claim 5, wherein the message further includes a caller identifier associated the caller device, and wherein the caller identifier is extracted from the message.

10. The method of claim 9, further comprising:
displaying the information associated with the first called identifier along with information associated with the caller identifier on a display of the terminal device to alert the user.

11. The method of claim 5, wherein alerting the user includes playing an audio alert corresponding to the first called identifier.

12. The method of claim 11, wherein the audio alert is a distinct ringtone uniquely associated with the first called identifier.

13. (canceled)

14. The method of claim 5, further wherein the information associated with the first called identifier includes address book contact information.

15. The method of claim 5, wherein the message is received via short message service (SMS) or through an audio channel.

16. The method of claim 5, wherein the message is a Session Initiation Protocol (SIP) message.

17. Apparatus for providing call identification to a terminal device, comprising:
a) at least one processor;
b) at least one input device; and
c) at least one storage device comprising an identification module configured to:
extract a first called identifier from a message associated with a call originating from a caller device directed to the first called identifier, wherein the call is forwarded to the terminal device associated with a second called identifier that is different from the first called identifier;
transmit information associated with the first called identifier to the terminal device;
modify a terminal identifier of the terminal device received in a second message associated with a return call originating from the terminal device to the caller device using the first called identifier; and
transmit the modified terminal identifier to the caller device.

18. The apparatus of claim 17, wherein the identification module is further configured to extract a caller identifier associated with the caller device from the message, and wherein the transmitted information further includes information associated with the caller identifier associated with the caller device.

19. The apparatus of claim 17, wherein transmitting is performed via a short message service (SMS) or through an audio channel.

20. The apparatus of claim 17, wherein the message is a Session Initiation Protocol (SIP) message.
